(19) United States
(12) Patent Application Publication
(10) Pub. No.: US 2015/0014409 A1
(43) Pub. Date: Jan. 15, 2015

(54) SERVICING SYSTEM FOR A FIELD DEVICE

(71) Applicant: ABB TECHNOLOGY AG, Zurich (CH)

(72) Inventors: Günter KUHLMANN, Kreiensen (DE); Markus BRODE, Göttingen (DE)

(21) Appl. No.: 14/326,991

(22) Filed: Jul. 9, 2014

(30) Foreign Application Priority Data
Jul. 9, 2013 (DE) 102013011402.0

(51) Int. Cl. G06F 17/30; G06K 19/06

(52) U.S. Cl. CPC G06F 17/30879; G06K 19/06037
USPC 235/375; 235/494

(57) ABSTRACT

An exemplary servicing system for a field device in an automation engineering installation. The servicing system is equipped with at least one sensor for converting a physical variable into an electrical variable and/or with at least one actuator for converting an electrical variable into a physical variable and also with a display device for presenting graphical characters. To dynamically provide a relatively high density of information, at least one subregion of the display device outputs a two-dimensional code, the content of which is alternatively made dynamic on the basis of the respective operating state of the field device and can be scanned by a mobile reader.

### RELATED APPLICATION(S)

This application claims priority under 35 U.S.C. §119 to German application DE 102013011402.0 filed in Germany on Jul. 9, 2013. The entire content of which is hereby incorporated by reference.

### FIELD

The present disclosure relates to a servicing system for a field device in an automation engineering installation.

### BACKGROUND INFORMATION

Known field devices are usually equipped with at least one sensor for converting a physical variable into an electrical variable and/or with at least one actuator for converting an electrical variable into a physical variable.

Moreover these field devices can be connected on a line—usually at least one two-wire line—to a superordinate device that is used in equal measure for the signal transmission of measured values, setpoint values and/or diagnosis data and for supplying power to the field device.

Furthermore, wireless field devices are known in which the signal transmission does not require a connecting line and that afford new opportunities in process automation. They allow the flexible installation of field devices in many situations that are not accessible to existing wired field devices.

Regardless of the type of remote data transmission between the field device and the superordinate device, further information items are retrieved directly from the field device in the course of in-situ servicing. To this end, the field device has a display device that is designed to visually display measured values, parameters, error reports and diagnosis data. As a result of the miniaturization of the field devices as such the display panel and also the resolution of this display device are very small. This has the result that alphanumeric characters can be displayed only to a limited extent, and only low-detailed graphics can be displayed in the case of graphical display devices. As a result, only a small number of information items can be presented at the same time, and complex facts cannot be reproduced at all.

Furthermore, the displayed data often do not immediately reveal the background or purpose that they have. As a result, the operating instructions are reviewed or the service department of the manufacturer is contacted, which in turn means time and cost involvement for the user. In this case, the requisite details concerning alarm/error reports, parameterization, conditions of use, installation advice, etc. are rarely available at the place of use. The context of information cannot always be presented meaningfully, such as what device parameters have what influence/effects or what could have caused the displayed error report.

These known systems should provide further detailed information at the place of installation of the field device in the automation engineering installation.

German utility model DE 20 2012 009 447 U1 discloses a field device for the instrumentation in the area of measurement and control engineering that is equipped with at least one graphically coded reference to a remote information content. In this case, this coded reference can be formed by a QR code. The remote information content is retrieved by capturing, decoding and retrieving the graphically coded reference using a reader. The reader specified is a smartphone. The stored identifier relates to a type information item (type plate) and a measuring point identifier.

Furthermore, German utility model 20 2012 102 138 U1 discloses an arrangement for reading identifier information items from a field device in which a two-dimensional code, such as a QR code or a dot matrix code, is provided for the purpose of furnishing a higher density of information.

Both known technical solutions have the drawback that they are of static design and hence are unsuitable for adding to dynamic information, such as alarm and error reports, in the servicing process.

### SUMMARY

An exemplary servicing system for a field device in an automation engineering installation is disclosed, including at least one of: at least one sensor for converting a physical variable into an electrical variable; and at least one actuator for converting an electrical variable into a physical variable; and a display device for presenting graphical characters, wherein at least one subregion of the display device is designed to output a two-dimensional code, the content of which is alternately dynamic on the basis of the respective operating state of the field device and can be scanned by a mobile reader.

### BRIEF DESCRIPTION OF THE DRAWINGS

In the drawings:

FIG. 1 illustrates a servicing system for a field device with a reader that has Internet capability in accordance with an exemplary embodiment of the present disclosure; and

FIG. 2 illustrates a servicing system for a field device with a reader that does not have Internet capability in accordance with an exemplary embodiment of the present disclosure.

### DETAILED DESCRIPTION

Exemplary embodiments of the present disclosure specify a servicing system for a field device in an automation engineering installation that is suitable for dynamically providing a higher density of information.

The exemplary embodiments disclosed herein start with a field device having a display device for presenting graphical characters.

According to an exemplary embodiment at least one subregion of the display device is designed to output a two-dimensional code, such as a QR code, the content of which is alternately dynamic based on the respective operating state of the field device, and can be scanned by a mobile reader.

In this case, further subregions of the display device can be designed to output process values and parameters in a previously known manner.

Specifically, in addition to the already known display contents, a two-dimensional code is provided that is recorded and interpreted using a reader.

The two-dimensional code provides at least one information item that refers to a location at which detailed information items can be retrieved that are unsuitable for display on the display device of the field device on account of their scope or their type.

If the reader has Internet capability, the detailed information items can be retrieved from the specified location as specified when there is an Internet connection.

In the absence of an Internet connection or an Internet capability on the reader, the source address (URL) of the specified location can be displayed to the user in plain text, and the detailed information can then be retrieved from said source address using another device, which has Internet capability.

The reader includes at least one camera for recording the two-dimensional code and a display apparatus for presenting the detailed information items and also processing means that are suitable for decoding the two-dimensional code and for conditioning its content for display. Further equipment of the reader is described in the respective embodiments.

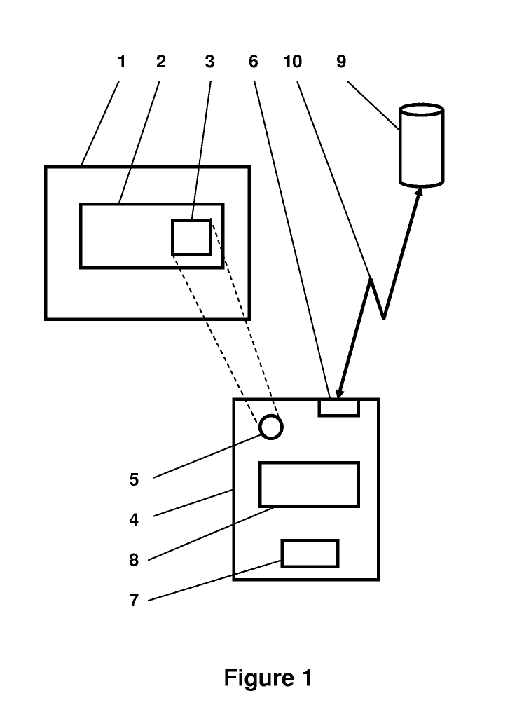

FIG. 1 illustrates a servicing system for a field device with a reader that has Internet capability in accordance with an exemplary embodiment of the present disclosure. As shown in FIG. 1, the field device 1 is equipped with a graphical display device 2 for the output of measured values, status information items and/or diagnosis information items.

The display panel of the graphical display device 2 has a subregion 3 formed on it for the output of a two-dimensional code, such as a QR code. The content of this code changes on the basis of the respective operating state of the field device 1.

The two-dimensional code can be scanned using a mobile reader 4. To this end, the reader 4 has at least one camera 5 for recording the two-dimensional code and a display apparatus 8 for presenting the detailed information items and also a processing means that are suitable for decrypting the two-dimensional code and conditioning the content thereof for display.

A suitable reader 4 of this kind can be in the form of, but is not limited to, smartphones and tablet PCs onto which a piece of application software (app) 7 has been loaded and is executed that is suitable for recognizing and decoding the two-dimensional code on the display panel of the graphical display device 2 of the field device 1.

The two-dimensional code provides at least one information item that refers to a location at which detailed information items can be retrieved that are unsuitable for display on the display device 2 of the field device 1 on account of their scope or their type. Thus, provision can be made for the location of a further information item for error handling to be output as a two-dimensional code in plain text on the display device 2 of the field device 1, besides the error status, in the event of an error in said field device.

Furthermore, provision can be made for the two-dimensional code to have details relating to the explicit identification of the field device 1.

Advantageously, this makes it possible to take account of revision statuses of field devices 1 of the same type for selection of the further information items.

According to a further feature, provision can be made for the two-dimensional code to have individual device-related data from the field device 1.

Advantageously, this makes it possible to take account of the conditions of use of the field device 1 for selection of further information items. In this case, the operating period and the temperature profile at the place of use, for example, can provide relevant advice in the event of error.

According to another exemplary embodiment, the reader 4 can have Internet capability. To this end, the reader 4 has a communication interface 6 that is suitable for setting up a communication link to the Internet.

When there is an Internet connection 10, the detailed information items are retrieved from the specified location—which can be a specific Internet page of the manufacturer of the field device 1—as specified, said location being stored in a database 9.

The detailed information items can be implemented as, but is not limited to, combined and/or detailed descriptions, possible steps for error correction in the event of existing alarm states for the field device 1, advice of possible causes in the event of an error, operating instructions, certificates, advice pertaining to process purposes/purposes of use, contact data for the service department, or manufacturer.

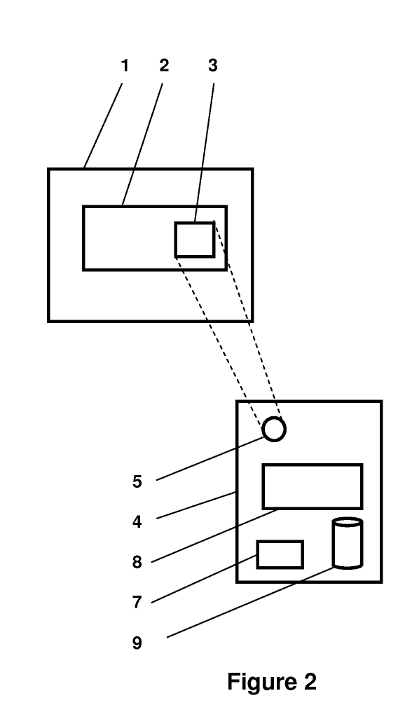

FIG. 2 illustrates a servicing system for a field device with a reader that does not have Internet capability in accordance with an exemplary embodiment of the present disclosure. FIG. 2 uses the same reference symbols for the same means to provide a basic illustration of the individual components of a servicing system for a field device 1 having a reader 4 that does not have Internet capability. As shown in FIG. 2, a reader 4 that does not have Internet capability is understood, within the context of this disclosure, to mean either a reader 4 without a communication interface or a reader 4 with a communication interface but without access to the Internet.

According to the exemplary embodiment as shown, the field device 1 is equipped with a graphical display device 2 for outputting measured values, status information items and/or diagnosis information items on which a subregion 3 is designed to output a two-dimensional code, such as a QR code, the content of which changes on the basis of the respective operating state of the field device 1.

The two-dimensional code can be scanned using a mobile reader 4 that has at least one camera 5 for recording the two-dimensional code and a display apparatus 8 for presenting the detailed information items and also processing means that are suitable for decrypting the two-dimensional code and conditioning the content thereof for display.

The two-dimensional code provides at least one information item that refers to a location at which detailed information items can be retrieved that are unsuitable for display on the display device 2 of the field device 1 on account of their scope or their type. Thus, provision can be made for the location of a further information item for error handling to be output as a two-dimensional code in plain text on the display device 2 of the field device 1, besides the error status, in the event of an error in said field device.

According to another exemplary embodiment of the present disclosure, the content of the decrypted code, for example, the location of the further information, can be output on the display apparatus 8. This output can take place in the form of a source address (URL) on the Internet. Another device, which has Internet capability, can be used to retrieve the further information stored at this source address (URL).

In another exemplary embodiment of the present disclosure, the reader 4 is equipped with a database 9 that contains the further information from the ascertained source address (URL) and provides it offline.

Such further information can have the following structure by way of example. From the explicit identification and the individual device-related data from the field device 1, it is evident that the error can be caused by an excessive housing interior temperature. The servicing personnel receives from the source, which is available online or offline, a detailed error description with first general advice. As an additional option, the servicing personnel is interactively questioned about the installation situation of the field device, for example about the medium temperature, the ambient temperature, the installation situation and the like. From the data collected, it is possible to infer adverse installation situations that, if they arise in combination, can result in problems, for example high medium temperatures and installation outdoors, where the field device 1 is exposed to sunlight at specified times of day. This then results in an inadmissibly high housing interior temperature. From this information, a possible solution proposal is derived to shade the field device 1, and this proposal is offered to the servicing personnel.

Regardless of the embodiment, the two-dimensional code can be designed to provide device parameters that are ascertained once and/or cyclically.

According to an exemplary embodiment of the present disclosure, provision can be made for an appropriate two-dimensional code to be output following clearance of an error/alarm state of the field device 1.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Field device
2 Display device
3 Subregion
4 Reader
5 Camera
6 Communication interface
7 Application software
8 Display apparatus
9 Database
10 Internet connection

What is claimed is:

1. A servicing system for a field device in an automation engineering installation, comprising:
at least one of:
at least one sensor for converting a physical variable into an electrical variable; and
at least one actuator for converting an electrical variable into a physical variable; and
a display device for presenting graphical characters, wherein at least one subregion of the display device is designed to output a two-dimensional code, the content of which is alternately dynamic on the basis of the respective operating state of the field device and can be scanned by a mobile reader.

2. The servicing system as claimed in claim 1, wherein the reader includes at least one camera for recording the two-dimensional code and a display apparatus for presenting detailed information items and also processing means that are suitable for decoding the two-dimensional code and for conditioning its content for display.

3. The servicing system as claimed in claim 1, wherein the two-dimensional code provides at least one information item that refers to a location at which detailed information items can be retrieved, the detailed items being unsuitable for display on the display device of the field device based on scope or type.

4. The servicing system as claimed in claim 3, wherein the reader includes at least one camera for recording the two-dimensional code and a display apparatus for presenting the detailed information items and also processing means that are suitable for decoding the two-dimensional code and for conditioning its content for display.

5. The servicing system as claimed in claim 4, wherein the two-dimensional code refers to a location at which detailed information items are kept for retrieval.

6. The servicing system as claimed in claim 5, wherein the reader has a communication interface that is suitable for setting up a communication link to the location on the Internet at which the detailed information items are kept for retrieval.

7. The servicing system as claimed in claim 5, wherein the reader is equipped with a database that contains the detailed information item from the location at which the detailed information items are kept for retrieval and provides it offline.
